(19) United States
(12) Patent Application Publication
(10) Pub. No.: US 2025/0125982 A1
(43) Pub. Date: Apr. 17, 2025

(54) DATA TRANSMISSION METHOD AND APPARATUS, COMMUNICATION DEVICE, AND COMPUTER READABLE STORAGE MEDIUM

(71) Applicant: TENCENT TECHNOLOGY (SHENZHEN) COMPANY LTD, Shenzhen (CN)

(72) Inventor: Zhuoyun ZHANG, Shenzhen (CN)

(73) Assignee: TENCENT TECHNOLOGY (SHENZHEN) COMPANY LTD, Shenzhen (CN)

(21) Appl. No.: 18/987,724

(22) Filed: Dec. 19, 2024

Related U.S. Application Data
(63) Continuation of application No. PCT/CN2023/104715, filed on Jun. 30, 2023.

(30) Foreign Application Priority Data
Nov. 9, 2022 (CN) 202211398843.2

(51) Int. Cl. H04L 12/14; H04L 41/0894; H04W 28/24

(52) U.S. Cl. CPC H04L 12/1407; H04L 41/0894; H04W 28/24

(57) ABSTRACT

A data transmission method, performed by a communication device corresponding to a policy control function entity, includes: obtaining first support capability information indicating whether a first network device supports a first capability for quality of service processing of a data packet set at a first moment; generating a first policy and charging control rule based on the first support capability information; and transmitting the first policy and charging control rule.

### CROSS-REFERENCE TO RELATED APPLICATIONS

This application is a continuation application of International Application No. PCT/CN2023/104715 filed on Jun. 30, 2023, which claims priority to Chinese Patent Application No. 202211398843.2, filed with the China National Intellectual Property Administration on Nov. 9, 2022, the disclosures of each being incorporated by reference herein in their entireties.

### FIELD

The disclosure relates to the field of communication technologies, and in particular, to a data transmission method and apparatus, a communication device, and a computer-readable storage medium.

### BACKGROUND

With the iterative deployment of new communication protocol versions during in mobile communication networks, there may be network devices using the network that support different protocol versions, and these devices may be unable to support new network performance features of new communication protocols through software updates. As a result, network compatibility problems may impact performance, or network devices supporting different capabilities may be unable to transmit data between each other using their respective supported protocols.

### SUMMARY

Provided are a data transmission method and apparatus, a communication device, and a computer-readable storage medium, capable of transmitting data under network device processing capabilities.

According to some embodiments, a data transmission method, performed by a communication device corresponding to a policy control function entity, includes: obtaining first support capability information indicating whether a first network device supports a first capability for quality of service processing of a data packet set at a first moment; generating a first policy and charging control rule based on the first support capability information; and transmitting the first policy and charging control rule.

According to some embodiments, a data transmission apparatus, includes: at least one memory configured to store computer program code; and at least one processor configured to read the program code and operate as instructed by the program code, the program code including: first obtaining code configured to cause at least one of the at least one processor to obtain first support capability information indicating whether a first network device supports a first capability for quality of service processing of a data packet set at a first moment; first generating code configured to cause at least one of the at least one processor to generate a first policy and charging control rule based on the first support capability information; and first transmitting code configured to cause at least one of the at least one processor to transmit the first policy and charging control rule.

According to some embodiments, a non-transitory computer-readable storage medium, storing computer code which, when executed by at least one processor, causes the at least one processor to at least: obtain first support capability information indicating whether a first network device supports a first capability for quality of service processing of a data packet set at a first moment; generate a first policy and charging control rule based on the first support capability information; and transmit the first policy and charging control rule.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a communication system architecture according to some embodiments.

FIG. 2 is a diagram of a system architecture of a 5G network according to some embodiments.

FIG. 3 is a schematic flowchart of a data transmission method according to some embodiments.

FIG. 4 is a schematic flowchart of a data transmission method according to some embodiments.

FIG. 5 is a schematic flowchart of a data transmission method according to some embodiments.

FIG. 6 is a schematic flowchart of a data transmission method according to some embodiments.

FIG. 7 is a schematic diagram of interaction of a data transmission method according to some embodiments.

FIG. 8 is a schematic block diagram of a data transmission apparatus according to some embodiments.

FIG. 9 is a schematic block diagram of a data transmission apparatus according to some embodiments.

FIG. 10 is a schematic diagram of a structure of a communication device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All some embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The technical solutions in the disclosure may be applied to various communication systems, for example, a global system for mobile communications (GSM) system, a code division multiple access (CDMA) system, a wideband code division multiple access (WCDMA) system, a general packet radio service (GPRS) system, a long term evolution (LTE) system, an LTE frequency division duplex (FDD) system, LTE time division duplex (TDD) system, a universal mobile communications system (UMTS), a worldwide interoperability for microwave access (WiMAX) communication system, a 5G system, or a future evolved mobile communication system.

For example, a communication system 100 applied to some embodiments is shown in FIG. 1. The communication system 100 may include a network device 110. The network device 110 may be a device that communicates with a terminal 120 (or referred to as a communication terminal). The network device 110 may provide communication coverage for a geographic area and may communicate with terminals located within the coverage area.

In some embodiments, the network device 110 may be a base transceiver station (BTS) in the GSM system or the CDMA system, a NodeB (NB) in the WCDMA system, an evolved NodeB (eNB or eNodeB) in the LTE system, a base station in a 5G communication system, or a wireless controller in a cloud radio access network (CRAN). Alternatively, the network device may be such as a mobile switching center, a relay station, an access point, a vehicle-mounted device, a wearable device, a hub, a switch, a bridge, a router, a network-side devices in a 5G network, a network access side device of a non-3^{rd} generation partnership project (3GPP) access method defined in the 5G network (such as a non-3GPP interworking function (N3IWF), a trusted non-3GPP gateway function entity (TNGF), a wireline access gateway function entity (W-AGF), or a trusted WLAN interworking function entity (TWIF)), or a network device in a future evolved public land mobile network (PLMN).

The communication system 100 further includes at least one terminal 120 located within the coverage of the network device 110. As used herein, “terminal” includes but is not limited to a terminal connected via a wired line, such as a public switched telephone network (PSTN), a digital subscriber line (DSL), a digital cable, and direct cable connection; and/or a terminal connected via a wireless interface, such as a cellular network, a wireless local area network (WLAN), a digital television network such as a DVB-H network, a satellite network, and an AM-FM broadcast transmitter; and/or an apparatus configured to receive/send a communication signal in another terminal; and/or an Internet of things (IoT) device.

A terminal configured to communicate through a wireless interface may be referred to as a “wireless communication terminal”, a “wireless terminal”, or a “mobile terminal”. An example of the mobile terminal includes, but is not limited to, a satellite or a cellular phone; a personal communication system (PCS) terminal that can combine a cellular radiotelephone with data processing, fax, and a data communication capability; a PDA that may include a radiotelephone, a pager, Internet/Intranet access, a Web browser, a planner, a calendar, and/or a global positioning system (GPS) receiver; and a conventional laptop and/or handheld receiver or another electronic device including a radiotelephone transceiver.

The terminal may be referred to as an access terminal, user equipment (UE), a subscriber unit, a subscriber station, a mobile station, a mobile console, a remote station, a remote terminal, a mobile device, a user terminal, a wireless communication device, a user agent, or a user apparatus. The access terminal may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal in the 5G network or a terminal in the future evolved PLMN, or the like.

In some embodiments, device to device (D2D) communication may be performed between terminals 120.

FIG. 1 illustrates an example network device and two terminals. In some embodiments, the communication system 100 may include a plurality of network devices. Other quantities of terminals may be included in the coverage of each network device, which is not limited.

In some embodiments, the communication system 100 may further include another network element such as a policy control function entity (PCF) or an access and mobility management function entity (AMF), which is not limited.

In some embodiments, a device having a communication function in a network/system may be referred to as a communication device. Taking the communication system 100 shown in FIG. 1 as an example, the communication device may include the network device 110 and the terminal 120 that have communication functions. The network device 110 and the terminal 120 may be the devices described above.

The terms “system” and “network” may be used interchangeably. The term “and/or” used herein describes only an association relationship for describing associated objects and represents that three relationships may exist. For example, A and/or B may represent the following three cases: only A exists, both A and B exist, and only B exists.

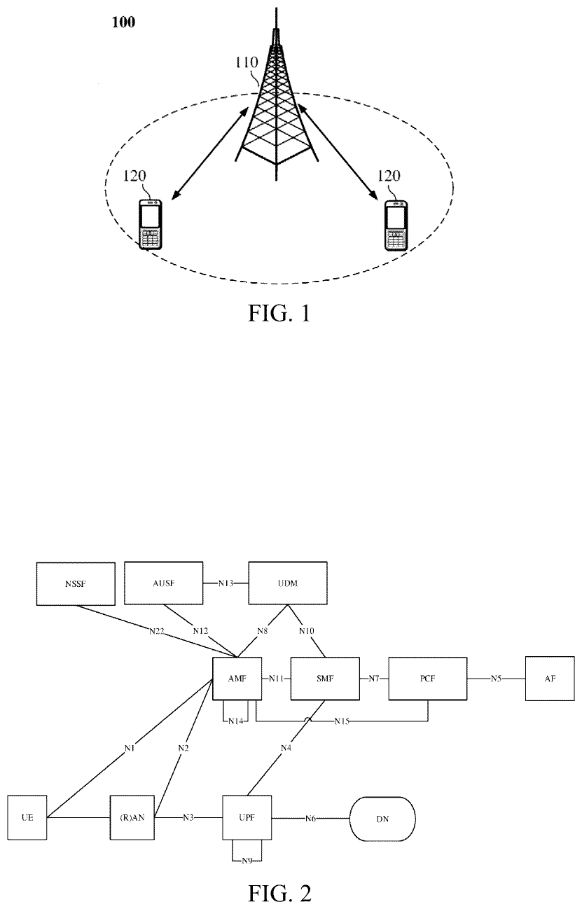

FIG. 2 is a diagram of a system architecture of a 5G network according to some embodiments. As shown in FIG. 2, devices included in the 5G network system include a terminal (UE), a radio access network (RAN), a user plane function entity (UPF), a data network (DN), an access and mobility management function entity (AMF), a session management function entity (SMF), a policy control function entity (PCF), an application function entity (AF), an authentication server function entity (AUSF), and a unified data management (UDM) network element.

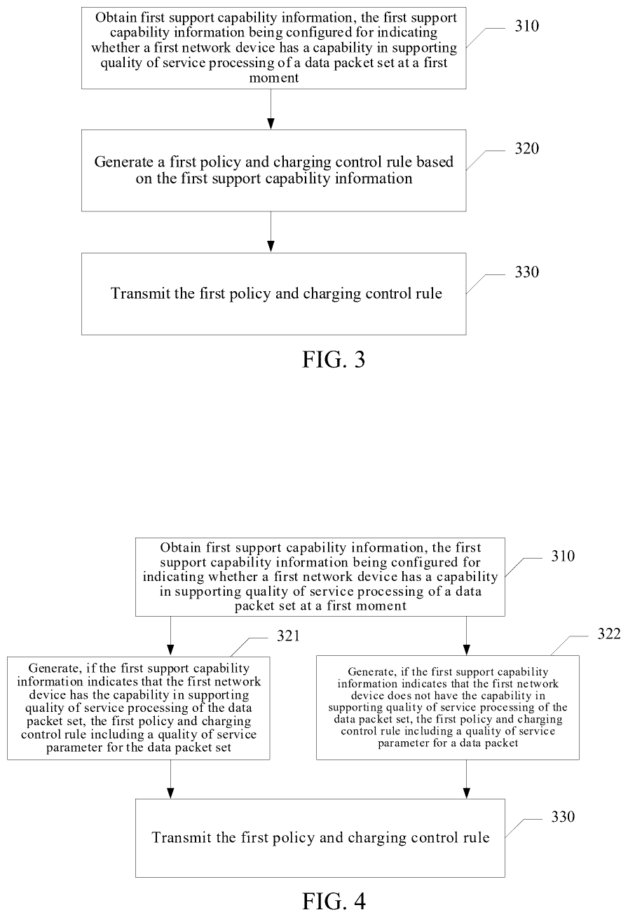

FIG. 3 is a schematic flowchart of a data transmission method according to some embodiments. The method provided in some embodiments as illustrated in FIG. 3, for example, may be performed by a communication device corresponding to a PCF, but the disclosure is not limited thereto. As shown in FIG. 3, the method provided in some embodiments may include the following operations.

310: Obtain first support capability information, the first support capability information being configured for indicating whether a first network device has a capability in supporting quality of service processing of a data packet set at a first moment.

The network device in some embodiments may be any device having a network function. In some embodiments, a base station is used, and the first network device may be any base station where a connection is established between the base station and UE, which is not limited.

In some embodiments, network transmission of data packets (such as multimedia data packets) in a quality of service (QoS) flow is optimized. The data packets (such as the multimedia data packets) are grouped for transmission, data packets that have the same or similar characteristics (features) and/or have strong interdependence are grouped into the same data packet set (for example, a protocol data unit (PDU) set, which can be abbreviated as PS), and data packets that do not have the same or similar characteristics (features) or do not have strong interdependence are grouped into different data packet sets. In some embodiments, various methods may be used to group the data packets.

In some embodiments, the data packets may be grouped based on different characteristics, data packets that have the same or similar characteristics may be grouped into the same group, and data packets that have different characteristics may be grouped into different groups. For example, a plurality of audio data packets are grouped into the same group, and a plurality of video data packets are grouped into the same group, or an I-frame data packet in the video data packets is grouped into a group, a P-frame data packet is grouped into another group, and a B-frame data packet is grouped into another group. Alternatively, data packets of base layers of frames in video frames may be grouped into the same group, or data packets of enhancement layers of frames may be grouped into the same group.

In some embodiments, the data packets may be grouped based on dependency between the data packets. Data packets with a dependency relationship may be grouped into the same group, and the data packets without the dependency relationship may be grouped into different groups. Whether different data packets are interdependent or have strong interdependence may be set depending on actual requirements, for example, depending on whether the data packets can be probably decoded and/or received only when the data packets are interdependent

For example, when it is determined whether different data packets have a close dependency relationship, if an encoded image or video data is transmitted in the data packets, it can be determined whether there is a close dependency relationship based on whether it is necessary to refer to other data packets when a client side (which may correspond to a terminal side) or a service server side decodes the encoded image or video data packet after the client side or the service server side receives the encoded image or video data packet. Different data packets that have a reference or referenced relationship during decoding may be considered to have a close dependency relationship, and different data packets that do not have the reference or referenced relationship during decoding may be considered to have no close dependency relationship.

In some embodiments, the data packets may be grouped based on importance of the data packets, key information in a target service flow may be grouped into a group, and non-key information may be grouped into another group. What information is set as the key information and what information is set as the non-key information may be based modified and is not limited.

In some embodiments, the data packet sets may be grouped based on two or more factors including the importance, dependency relationship, similar or identical characteristics, and the like of the data packets. For example, data packets of key information and non-key information that have a dependency relationship in the target service flow may be grouped into a data packet set respectively. A quantity of groups is not limited, and these data packet sets may or may not have a dependency relationship. A method of grouping the data packet sets is not limited.

In some embodiments, the QoS flow refers to a service flow for the UE. The service flow refers to, for one or some services, a service flow formed by an uplink data packet sent by the terminal and/or a downlink data packet sent by the service server during transmission over a network. A service may be set based on actual needs. For example, the service may be a multimedia service, and a corresponding data packet includes a multimedia data packet, but the disclosure is not limited thereto.

In some embodiments, for a data packet set, for example, the PDU set, the network may determine QoS profile information (quality of service profile information) for the data packet set. The QoS profile information for the data packet set may include a QoS parameter for the data packet set. The QoS profile information for the data packet set may be provided for a base station (for example, the first network device here, where in this case, the corresponding QoS profile information may be referred to as first quality of service profile information for distinction) transmitting the QoS flow, so that the base station can perform corresponding processing based on the QoS parameter for the data packet set.

An example in which a 5G network transmission mechanism and the multimedia data packet are used is provided, but the disclosure is not limited thereto. For the multimedia data packet, QoS scheduling is to be performed for the multimedia data packet set in the network, to define the QoS profile information for the data packet set. The QoS profile information for the data packet set may include a QoS parameter for the data packet set, such as at least one of a PDU set error rate (PSER) or a PDU set delay budget (PSDB), and may further include at least one of a guaranteed flow bit rate (GFBR), a max flow bit rate (MFBR), or the like.

The PSDB defines an upper limit of a delay for the data packet set to be transmitted between the UE and a UPF. The PSER defines, over a measurement window, an upper limit on a ratio of a quantity of data packet sets that are not successfully received to a total quantity of sent data packet sets. Detailed definitions of the PSDB and the PSER follow the relevant specifications or research reports of the 3GPP.

In some embodiments, the QoS flow may be a QoS flow for a guaranteed bit rate (GBR) or a QoS flow for a non-guaranteed bit rate (non-GBR). If the QoS flow is the QoS flow for the non-GBR, the QoS parameter for the data packet set may not include GFBR and MFBR information; if the QoS flow is the QoS flow for the GBR, the QoS parameter for the data packet set may further include at least one of GFBR information or MFBR information. In other words, in some embodiments, a QoS enhancement mechanism for the data packet sets is provided, and QoS parameter information for the data packet sets is provided.

However, in an actually deployed network, not all base stations have a capability in supporting QoS processing of the data packet set. Therefore, in some embodiments, “support capability information” is provided. The support capability information may be configured for indicating whether a corresponding network device (such as a base station) has the capability in supporting quality of service processing of the data packet set.

In some embodiments, the first support capability information is configured for indicating whether the first network device has the capability in supporting quality of service processing of the data packet set at the first moment. If the first support capability information indicates that the first network device has the capability in supporting QoS processing of the data packet set, it means that the first network device supports a quality of service parameter or quality of service parameter information set for the data packet set. If the first support capability information indicates that the first network device does not have the capability in supporting QoS processing of the data packet set, it means that the first network device does not support a quality of service parameter or quality of service parameter information set for the data packet set.

In some embodiments, a variety of methods may be used to indicate whether the corresponding network device has the capability in supporting quality of service processing of the data packet set. In some embodiments, a parameter of “information about a base station having a capability in supporting QoS processing of a data packet set” may be defined as support capability information of a corresponding network device. The parameter may be configured for indicating whether a corresponding base station has the capability in supporting QoS processing of the data packet set.

For example, when the PCF can obtain the parameter, it indicates that the corresponding network device has the capability in supporting quality of service processing of the data packet set. When the PCF cannot obtain the parameter, it indicates that the corresponding network device does not have the capability in supporting quality of service processing of the data packet set.

For another example, when the parameter value is a first value, it indicates that the corresponding network device has the capability in supporting quality of service processing of the data packet set. When the parameter value is a second value, it indicates that the corresponding network device does not have the capability in supporting quality of service processing of the data packet set. However, the setting of the first value and the second value is not limited thereto.

In some embodiments, the obtaining first support capability information includes at least one of the following:
obtaining the first support capability information from a target core network-network element, the first support capability information being pre-configured in the target core network-network element, and the target core network-network element including at least one of a policy control function entity, a unified data management network element, or a unified data repository (UDR) network element;
obtaining the first support capability information from a network management system; or
obtaining the first support capability information from the first network device.

For example, if the parameter of “information about a base station having a capability in supporting QoS processing of a data packet set” is used as the first support capability information of the corresponding network device, the parameter may be pre-configured in the target core network-network element (such as the PCF, a UDM, and the UDR) of the core network, or sent, through a network management system, to a network element (the PCF) that may use the information in the core network, or sent, through a network element such as an AMF, by the corresponding base station to a network element (the PCF) that may use the information in the core network.

320: Generate a first policy and charging control rule based on the first support capability information.

In some embodiments, the PCF may set the first policy and charging control (PCC) rule based on various factors such as an operator policy, network information, the first support capability information, and service demand information received from an application function entity (AF). For example, if the first support capability information indicates that the first network device has the capability in supporting quality of service processing of the data packet set, the first PCC rule set by the PCF may include the quality of service parameter for the data packet set; or if the first support capability information indicates that the first network device does not have the capability in supporting quality of service processing of the data packet set, the first PCC rule set by the PCF may not include the quality of service parameter for the data packet set, but the disclosure is not limited thereto. The PCF then transmits the set first PCC rule to the SMF.

In some embodiments, different methods may be used to indicate that the first PCC rule does not include the quality of service parameter for the data packet set.

In some embodiments, an indication field may be added to the first PCC rule. When a value of the indication field is a first value, it indicates that the first PCC rule includes the quality of service parameter for the data packet set. When a value of the indication field is a second value, it indicates that the first PCC rule does not include the quality of service parameter for the data packet set.

In some embodiments, when the first PCC rule includes the foregoing indication field, it indicates that the PCC rule includes the quality of service parameter for the data packet set. When the first PCC rule does not include the foregoing indication field, it indicates that the first PCC rule does not include the quality of service parameter for the data packet set.

In some embodiments, the first PCC rule may directly carry the quality of service parameter for the data packet set; or the first PCC rule may carry a quality of service parameter for a data packet, to indicate that the first PCC rule does not include the quality of service parameter for the data packet set.

330: Transmit the first policy and charging control rule.

The PCF may transmit the foregoing first PCC rule to the SMF.

In some embodiments, the method provided may further include: obtaining a second notification message, where the second notification message may include third support capability information, the third support capability information may be different from the first support capability information, and the third support capability information may be configured for indicating whether the first network device has a capability in supporting quality of service processing of the data packet set at a second moment; generating a third policy and charging control rule based on the third support capability information; and transmitting the third policy and charging control rule.

In some embodiments, when current and subsequent data transmission support capabilities of the first network device change, the first network device may transmit the second notification message to the PCF. The second notification message may be configured for indicating a current data transmission support capability of the first network device. The data transmission support capability may change from a previously sent data transmission support capability. After receiving the second notification message, the PCF may adaptively perform adjustment to generate a new PCC rule (referred to as a third PCC rule here for distinction), and transmit the new PCC rule to the SMF. After receiving the new PCC rule, the SMF may use the new PCC rule to replace the first PCC rule previously received from the PCF.

In some embodiments, the second notification message may carry the third support capability information, and the third support capability information is different from the first support capability information, to notify the PCF that the data transmission support capability of the first network device has changed, but the disclosure is not limited thereto.

In some embodiments, the second notification message may carry information to indicate that the data transmission support capability of the first network device has changed. Because the PCF has previously learned, based on the first support capability information, whether the first network device has the capability in supporting quality of service processing of the data packet set, it can be determined, based on the information indicated, whether the first network device has the capability in supporting quality of service processing of the data packet set at a current moment.

For example, assuming that the first support capability information indicates that the first network device has the capability in supporting quality of service processing of the data packet set at a previous moment (for example, the first moment), then the third support capability information may indicate that the first network device does not have the capability in supporting quality of service processing of the data packet set at the current moment (for example, the second moment).

For another example, assuming that the first support capability information indicates that the first network device has the capability in supporting quality of service processing of the data packet set at the previous moment, and the second notification message indicates that the data transmission support capability of the first network device at the current moment has changed, then the PCF may learn, based on the second notification message and the first support capability information at the previous moment, that the first network device does not have the capability in supporting quality of service processing of the data packet set at the current moment.

In some embodiments, when the first support capability information indicates that the first network device has the capability in supporting quality of service processing of the data packet set at the first moment, and the third support capability information indicates that the first network device does not have the capability in supporting quality of service processing of the data packet set at the second moment, the second notification message may further include a reason value, where the reason value may be configured for indicating a reason why the first network device does not have the capability in supporting quality of service processing of the data packet set at the second moment.

For example, when the QoS flow is established, it is assumed that the base station has the capability in supporting quality of service processing of the data packet set at the previous moment. When the base station cannot process the QoS flow for the data packet set at the current moment due to reasons such as a heavy load, the base station may send a notification (referred to as the second notification message for distinction) to the PCF and send the reason value. The PCF determines, based on the second notification message, that the base station cannot support QoS parameter processing of the data packet set. In some embodiments, if the PCF may further determine, based on the second notification message, that the first network device may support that the updated third PCC rule may include a QoS parameter for a data packet based on processing of the data packet at the current moment.

According to the data transmission method provided in some embodiments, the policy control function entity obtains the first support capability information, where the first support capability information can be configured for indicating whether the first network device has the capability in supporting quality of service processing of the data packet set at the first moment, so that the policy control function entity can generate, based on the first support capability information, the first policy and charging control rule that is compatible with the quality of service processing capability of the first network device, thereby enabling data to be transmitted normally in a case that network device processing capabilities are different.

In some embodiments, the generating a first policy and charging control rule based on the first support capability information may include: generating, if the first support capability information indicates that the first network device has the capability in supporting quality of service processing of the data packet set, the first policy and charging control rule including a quality of service parameter for the data packet set; or generating, if the first support capability information indicates that the first network device does not have the capability in supporting quality of service processing of the data packet set, the first policy and charging control rule including a quality of service parameter for a data packet.

FIG. 4 is a schematic flowchart of a data transmission method according to some embodiments. The method provided in some embodiments as illustrated in FIG. 4, for example, may be performed by a communication device corresponding to a PCF. As shown in FIG. 4, the method provided in some embodiments may include the following operations.

310: Obtain first support capability information, the first support capability information being configured for indicating whether a first network device has a capability in supporting quality of service processing of a data packet set at a first moment.

321: Generate, if the first support capability information indicates that the first network device has the capability in supporting quality of service processing of the data packet set, the first policy and charging control rule including a quality of service parameter for the data packet set.

322: Generate, if the first support capability information indicates that the first network device does not have the capability in supporting quality of service processing of the data packet set, the first policy and charging control rule including a quality of service parameter for a data packet.

330: Transmit the first policy and charging control rule.

According to the data transmission method provided in some embodiments, the PCF of a core network may determine, based on the first support capability information, whether the first network device (such as a base station) transmitting a QoS flow has the capability in supporting QoS processing of the data packet set, to determine relevant QoS parameter information in the first PCC rule of the QoS flow. In other words, if the first network device has the capability in supporting QoS processing of the data packet set, the first PCC rule includes the QoS parameter information for the data packet set. If the first network device does not have the capability in supporting QoS processing of the data packet set, the first PCC rule may be set according to a relevant mechanism. The first PCC rule does not include relevant information about processing of the data packet set, for example, may include QoS parameter information for the data packet. The PCF may transmit the set first PCC rule to an SMF. In other words, when the base station does not support a QoS guarantee for the data packet set, a corresponding solution is provided for the QoS parameter for data packet set transmission.

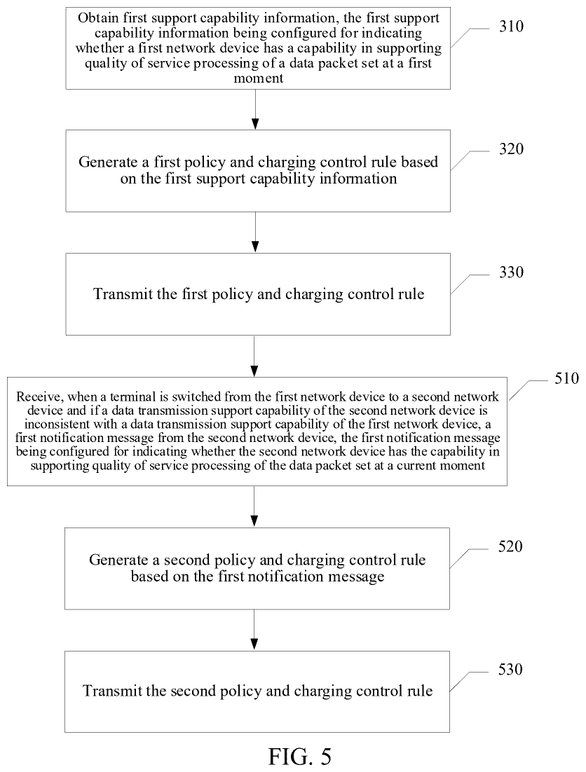

FIG. 5 is a schematic flowchart of a data transmission method according to some embodiments. The method provided in some embodiments as illustrated in FIG. 5, for example, may be performed by a communication device corresponding to a PCF. The method provided illustrated FIG. 5 may further include the following operations.

510: Receive, when a terminal is switched from the first network device to a second network device and if a data transmission support capability of the second network device is inconsistent with a data transmission support capability of the first network device, a first notification message from the second network device, the first notification message being configured for indicating whether the second network device has a capability in supporting quality of service processing of the data packet set at a current moment.

For example, when UE is switched from a source base station to a target base station, the source base station may be the first network device, and the target base station may be the second network device. When the data transmission support capability of the source base station is inconsistent with the data transmission support capability of the target base station, there may be one situation where the source base station has the capability in supporting QoS processing of the data packet set, while the target base station does not have the capability in supporting QoS processing of the data packet set. There may be another situation where the source base station does not have the capability in supporting QoS processing of the data packet set, while the target base station has the capability in supporting QoS processing of the data packet set. In this case, the target base station may send a notification to the PCF (referred to as the first notification message here for distinction) to notify the PCF that the data transmission support capability of the target base station to which the UE is switched changes compared with the source base station, or directly indicate whether the target base station has the capability in supporting quality of service processing of the data packet set.

In some embodiments, the first notification message may carry second support capability information configured for indicating whether the target base station has the capability in supporting quality of service processing of the data packet set at a current moment.

In some embodiments, the first notification message may indicate, through a designated field, that the data transmission support capability of the target base station at the current moment is different from the capability indicated by the first support capability information of the first network device.

In some embodiments, when the terminal is switched from the first network device to the second network device and if the data transmission support capability of the second network device is consistent with the data transmission support capability of the first network device, the PCF may not receive the foregoing first notification message from the second network device. In this case, the PCF may not update the first PCC rule.

520: Generate a second policy and charging control rule based on the first notification message.

530: Transmit the second policy and charging control rule.

Under both two cases, the PCF updates the PCC rule and generates the corresponding second PCC rule based on the data transmission support capability of the target base station.

For example, when the source base station supports QoS processing of the data packet set and corresponding first QoS profile information also includes QoS profile information for the data packet set, if the switching is performed between the UE and the base station due to movement and the target base station does not have the capability in supporting QoS processing of the data packet set, the target base station transmits information indicating that the QoS profile for the data packet set is not supported (which may be carried in the first notification message) to the PCF. The PCF updates the PCC rule of a QoS flow, obtains the second PCC rule, and transmits the second PCC rule including the QoS parameter information for the data packet to an SMF.

According to the data transmission method provided in some embodiments, when the switching is performed between the UE and the base station, if the data transmission support capability of the target base station after the switching is different from that of the source base station before the switching, the PCF may update the first PCC rule and transmit the updated second PCC rule to the SMF, to ensure that data can be transmitted normally after the switching is performed between the UE and the base station.

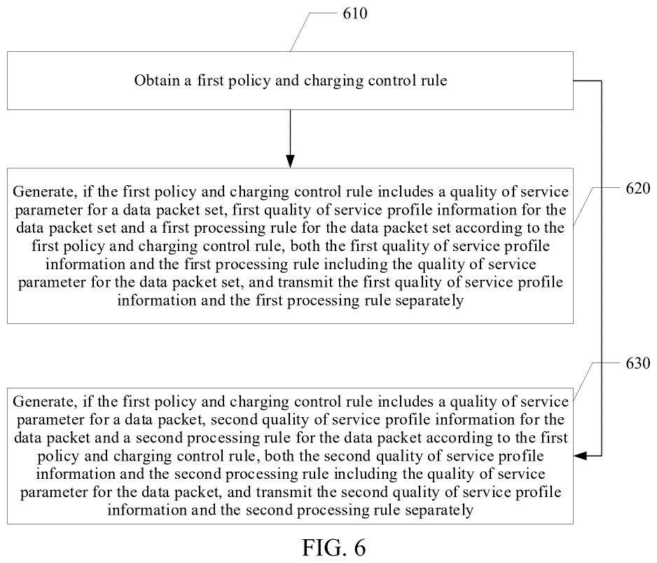

FIG. 6 is a schematic flowchart of a data transmission method according to some embodiments. The method provided in some embodiments as illustrated in FIG. 6, for example, may be performed by a communication device corresponding to an SMF, but the disclosure is not limited thereto. As shown in FIG. 6, the method provided in some embodiments may include the following operations.

610: Obtain a first policy and charging control rule.

620: Generate, if the first policy and charging control rule includes a quality of service parameter for a data packet set, first quality of service profile information for the data packet set and a first processing rule for the data packet set according to the first policy and charging control rule, where both the first quality of service profile information and the first processing rule may include the quality of service parameter for the data packet set; and transmit the first quality of service profile information and the first processing rule separately.

In some embodiments, after the SMF receives the foregoing first PCC rule from a PCF, if the first PCC rule includes the QoS parameter for the data packet set, the SMF may generate the first QoS profile information for the data packet set and the first processing rule for the data packet set according to the first PCC rule, and the SMF may transmit the first QoS profile information to a first network device (such as a base station) and transmit the first processing rule to a UPF.

630: Generate, if the first policy and charging control rule includes a quality of service parameter for a data packet, second quality of service profile information for the data packet and a second processing rule for the data packet according to the first policy and charging control rule, both the second quality of service profile information and the second processing rule including the quality of service parameter for the data packet, and transmit the second quality of service profile information and the second processing rule separately.

In some embodiments, after the SMF receives the foregoing first PCC rule from a PCF, if the first PCC rule includes the QoS parameter for the data packet, the SMF may generate the second QoS profile information for the data packet and the second processing rule for the data packet according to the first PCC rule, and the SMF may transmit the second QoS profile information to a first network device (such as a base station) and transmit the second processing rule to a UPF.

Further, some embodiments further provide a data transmission method. The method may be performed by a second network device, and the method may include: transmitting, when a terminal is switched from a first network device to the second network device and if a data transmission support capability of the second network device is inconsistent with a data transmission support capability of the first network device, a first notification message, where the first notification message may be configured for indicating whether the second network device has a capability in supporting quality of service processing of a data packet set.

In some embodiments, the method may further include: starting a timer; and refusing to establish the quality of service flow if third quality of service profile information generated in response to the first notification message is not received within predetermined duration set in the timer.

When a source base station supports QoS processing of the data packet set and first QoS profile information also includes QoS profile information for the data packet set, if switching is performed between UE and a base station due to movement and a target base station does not have the capability in supporting QoS processing of the data packet set, the target base station transmits information indicating that the QoS profile for the data packet set is not supported to a PCF. The PCF updates a PCC rule of a QoS flow and transmits the QoS information for the data packet to an SMF. The SMF generates the third QoS profile information and a UPF processing rule (referred to as a third processing rule) according to an updated PCC rule. The SMF transmits updated QoS profile information to the target base station, and the target base station establishes the QoS flow based on the updated QoS profile information. The SMF transmits an updated UPF processing rule to the UPF, and the UPF updates a corresponding processing rule to process a data flow.

In some embodiments, when the target base station transmits the information indicating that the QoS profile for the data packet set is not supported to the PCF, a timer may be started. If no updated QoS profile information (referred to as the third QoS profile information) is received from the PCF after time set in the timer is out, establishment of the QoS flow is rejected.

Further, some embodiments further provide a data transmission method. The method may be performed by a first network device. The method provided in some embodiments may include: receiving first quality of service profile information generated according to a first policy and charging control rule, where the first policy and charging control rule may be generated based on first support capability information, and the first support capability information may be configured for indicating whether the first network device has a capability in supporting quality of service processing of a data packet set at a first moment.

In some embodiments, the method may further include: transmitting, when a data transmission support capability of the first network device changes, a second notification message, the second notification message including third support capability information, and the third support capability information being different from the first support capability information.

For example, after a QoS flow is established, at a current moment, when a base station cannot process the QoS flow for the data packet set due to reasons such as a large load, the base station may send a notification (referred to as the second notification message for distinction) to a PCF. In some embodiments, the base station may further transmit a reason value to the PCF. When the PCF determines, based on the second notification message, that the base station cannot support QoS parameter processing of the data packet set, but may support processing based on a data packet, the PCC rule is updated. The SMF generates QoS profile information for the data packet according to an updated PCC rule and transmits the QoS profile information for the data packet to the base station. The SMF also generates an updated UPF processing rule based on the updated PCC rule, which includes processing rule information for the data packet.

According to the data transmission method provided in some embodiments, a compatibility solution for performing QoS control for the data packet set of the service flow is provided to ensure that the mechanism can be used correctly in a network, thereby optimizing a network transmission capacity.

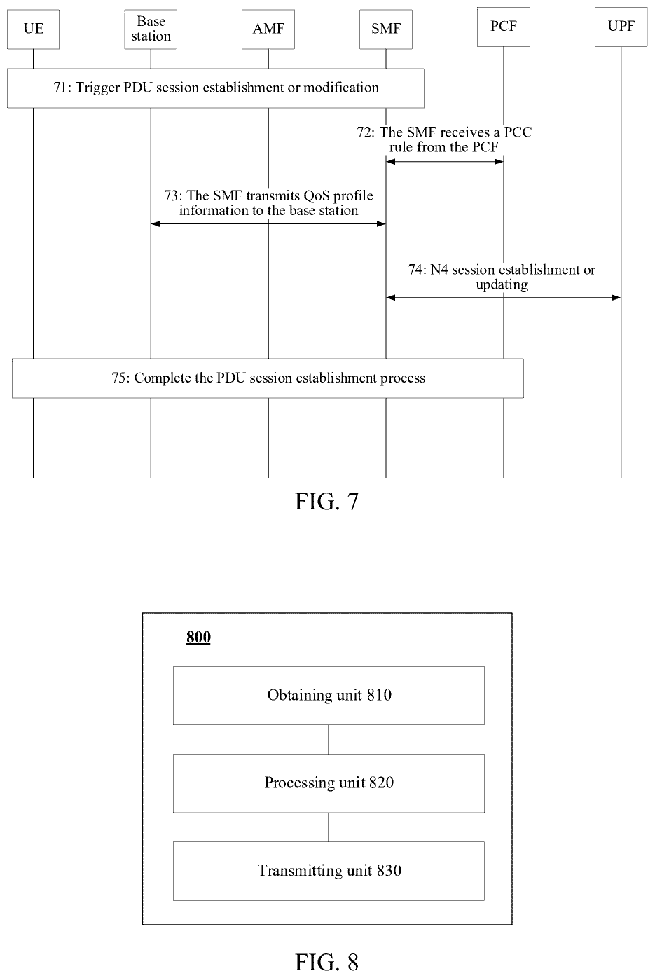

FIG. 7 is a schematic diagram of interaction of a data transmission method according to some embodiments. As shown in FIG. 7, an example in which a network device is a base station is used for description. The method may include the following operations.

71: Trigger a PDU session establishment or modification process.

In some embodiments, UE triggers the PDU session establishment or modification process, or a network triggers the PDU session establishment or modification process to establish or modify a PDU session (such as a data network name (DNN), single network slice selection assistance information (S-NSSAI)) of a service.

72: An SMF receives a PCC rule (which may be the foregoing first PCC rule, the second PCC rule, or the third PCC rule) from a PCF.

The PCF determines or updates the PCC rule based on whether a base station has information about a capability in supporting QoS processing of a data packet set. The SMF receives a new PCC rule from the PCF, and the new PCC rule may also be an updated PCC rule.

73: The SMF transmits QoS profile information (which may be the foregoing first QoS profile information, the second QoS profile information, or the third QoS profile information) to the base station.

When receiving the first PCC rule from the PCF, the SMF generates the first QoS profile information, and in some embodiments, may alternatively generate a first processing rule. When receiving the second PCC rule from the PCF, the SMF generates the second QoS profile information, and in some embodiments, may alternatively generate a second processing rule. When receiving the third PCC rule from the PCF, the SMF generates the third QoS profile information, and in some embodiments, may alternatively generate a third processing rule.

When a corresponding PCC rule includes processing of and a QoS parameter for the data packet set, the SMF generates corresponding QoS profile information (such as a PSER and a PSDB) for the data packet set and a corresponding processing rule of a UPF for the data packet set according to the corresponding PCC rule.

If a corresponding PCC rule does not include relevant processing information for the data packet set, the SMF generates corresponding QoS profile information for a data packet and a corresponding processing rule of the UPF according to the corresponding PCC rule. The SMF transmits the corresponding QoS profile information to the base station.

74: The SMF and the UPF perform an N4 session establishment or update a process.

The SMF and the selected UPF initiate the N4 interface session establishment or update a process. The SMF may transmit the foregoing first processing rule, second processing rule, or third processing rule to the UPF.

75: Complete the PDU session establishment process.

A network completes the PDU session establishment or modification process.

According to the data transmission method provided in some embodiments, QoS control is performed for the data packet set of a service flow, thereby optimizing a network transmission mechanism; and for transmission of the data packet (such as a multimedia data packet) in a communication network, a data transmission method that may be applied to a mobile communication network is provided. A parameter is defined, for example, support capability information is defined, to indicate whether the base station has the capability in supporting QoS processing of the data packet set, to determine whether to use a QoS optimization scheme based on the data packet set. In this way, compatibility of the scheme is considered during the transmission of the data packet set, to normally process the data packet under different base station processing capabilities.

FIG. 8 is a schematic block diagram of a data transmission apparatus corresponding to a session management function entity according to some embodiments. As shown in FIG. 8, the data transmission apparatus 800 provided in some embodiments may include an obtaining unit 810, a processing unit 820, and a transmitting unit 830.

The obtaining unit 810 may be configured to obtain first support capability information, the first support capability information being configured for indicating whether a first network device has a capability in supporting quality of service processing of a data packet set at a first moment.

The processing unit 820 may be configured to generate a first policy and charging control rule based on the first support capability information.

The transmitting unit 830 may be configured to transmit the first policy and charging control rule.

In some embodiments, the processing unit 820 may be further configured to: generate, if the first support capability information indicates that the first network device has the capability in supporting quality of service processing of the data packet set, the first policy and charging control rule including a quality of service parameter for the data packet set; or generate, if the first support capability information indicates that the first network device does not have the capability in supporting quality of service processing of the data packet set, the first policy and charging control rule including a quality of service parameter for a data packet.

In some embodiments, the obtaining unit 810 may obtain the first support capability information in at least one of the following manners:
obtaining the first support capability information from a target core network-network element, where the first support capability information is pre-configured in the target core network-network element, and the target core network-network element may include at least one of a policy control function entity, a unified data management network element, or a unified data repository network element;
obtaining the first support capability information from a network management system; or
obtaining the first support capability information from the first network device.

In some embodiments, the obtaining unit 810 may be further configured to:
receive, when a terminal is switched from the first network device to a second network device and if a data transmission support capability of the second network device is inconsistent with a data transmission support capability of the first network device, a first notification message from the second network device, the first notification message being configured for indicating whether the second network device has a capability in supporting quality of service processing of the data packet set at a current moment;
generate a second policy and charging control rule based on the first notification message; and
transmit the second policy and charging control rule.

In some embodiments, the obtaining unit 810 may be further configured to:
obtain a second notification message, the second notification message including third support capability information, the third support capability information being different from the first support capability information, and the third support capability information being configured for indicating whether the first network device has a capability in supporting quality of service processing of the data packet set at a second moment;
generate a third policy and charging control rule based on the third support capability information; and
transmit the third policy and charging control rule.

In some embodiments, when the first support capability information indicates that the first network device has the capability in supporting quality of service processing of the data packet set at the first moment, and the third support capability information indicates that the first network device does not have the capability in supporting quality of service processing of the data packet set at the second moment, the second notification message further includes a reason value, and the reason value is configured for indicating a reason why the first network device does not have the capability in supporting quality of service processing of the data packet set at the second moment.

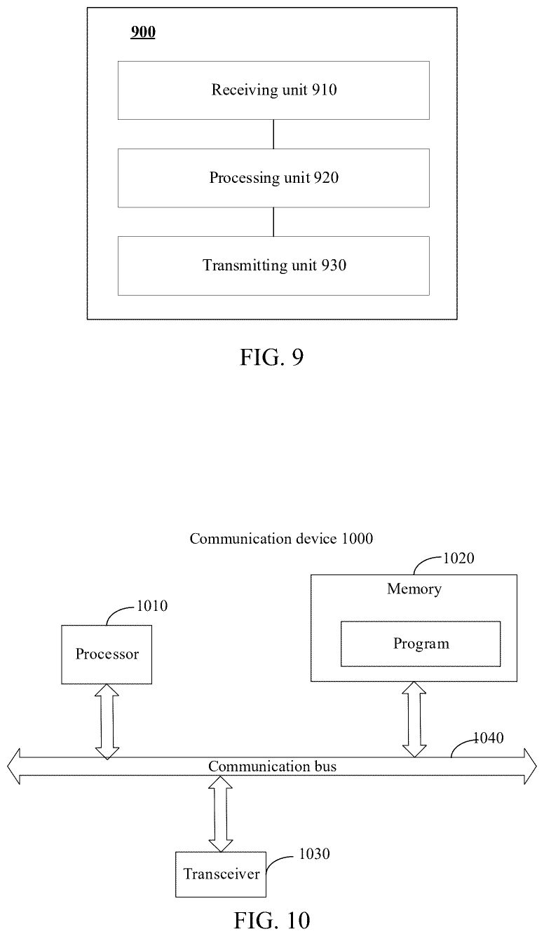

FIG. 9 is a schematic block diagram of a data transmission apparatus corresponding to a session management function entity according to some embodiments. As shown in FIG. 9, the data transmission apparatus 900 provided in some embodiments may include a receiving unit 910, a processing unit 920, and a transmitting unit 930.

The receiving unit 910 may be configured to obtain a first policy and charging control rule.

The processing unit 920 may be configured to generate, if the first policy and charging control rule includes a quality of service parameter for a data packet set, first quality of service profile information for the data packet set and a first processing rule for the data packet set according to the first policy and charging control rule, both the first quality of service profile information and the first processing rule including the quality of service parameter for the data packet set, or generate, if the first policy and charging control rule includes a quality of service parameter for a data packet, second quality of service profile information for the data packet and a second processing rule for the data packet according to the first policy and charging control rule, both the second quality of service profile information and the second processing rule including the quality of service parameter for the data packet.

The transmitting unit 930 may be configured to: transmit the first quality of service profile information and the first processing rule separately, or transmit the second quality of service profile information and the second processing rule separately.

Further, some embodiments provide a second network device. The second network device may include:
a transmitting unit, which may be configured to transmit, when a terminal is switched from a first network device to the second network device and if a data transmission support capability of the second network device is inconsistent with a data transmission support capability of the first network device, a first notification message, where the first notification message may be configured for indicating whether the second network device has a capability in supporting quality of service processing of a data packet set.

In some embodiments, the second network device may further include:
a processing unit, which may be configured to start a timer; and refuse to establish a corresponding quality of service flow if third quality of service profile information generated in response to the first notification message is not received within predetermined duration set in the timer.

Further, some embodiments provide a first network device. The first network device may include:
a receiving unit, which may be configured to receive first quality of service profile information generated according to a first policy and charging control rule, the first policy and charging control rule being generated based on first support capability information, and the first support capability information being configured for indicating whether the first network device has a capability in supporting quality of service processing of a data packet set at a first moment.

In some embodiments, the first network device may further include:
a transmitting unit, which may be configured to transmit, when a data transmission support capability of the first network device changes, a second notification message, the second notification message including third support capability information, and the third support capability information being different from the first support capability information.

According to some embodiments, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

FIG. 10 is a schematic diagram of a structure of a communication device 1000 according to some embodiments. The communication device may be a terminal such as UE, or a base station (including the foregoing source base station and target base station), or a PCF and/or an AMF and/or an SMF and/or a UPF. The communication device 1000 shown in FIG. 10 includes a processor 1010, and the processor 1010 may call and run a computer program from a memory to implement the method in some embodiments.

In some embodiments, as shown in FIG. 10, the communication device 1000 may further include the memory 1020. The processor 1010 may call and run the computer program from the memory 1020 to implement the method according to some embodiments.

The memory 1020 may be a separate component independent of the processor 1010, or may be integrated into the processor 1010.

In some embodiments, as shown in FIG. 10, the communication device 1000 may further include a transceiver 1030, and the processor 1010 may control the transceiver 1030 to communicate with another device, to send information or data to another device, or to receive information or data sent by another device.

The transceiver 1030 may include a transmitter and a receiver. The transceiver 1030 may further include an antenna, and there may be one or more antennas.

In some embodiments, the processor 1010, the memory 1020, and the transceiver 1030 may communicate with each other via a communication bus 1040.

In some embodiments, the communication device 1000 may be various network elements provided in the disclosure, and the communication device 1000 may implement the corresponding processes implemented by the network elements in the various methods of some embodiments.

In some embodiments, the communication device 1000 may be the network device (such as the first network device or the second network device) in some embodiments, and the communication device 1000 may implement the corresponding processes implemented by the network device in the various methods in some embodiments.

The processor in some embodiments may be an integrated circuit chip having a signal processing capability. In an implementation process, operations in the method according to some embodiments may be implemented by a hardware integrated logic circuit in the processor, or by instructions in a form of software.

The processor may be a general-purpose processor, a digital signal processor (DSP), an application-specific integrated circuit (ASIC), a field programmable gate array (FPGA), or another programmable logic device, a discrete gate or transistor logic device, or a discrete hardware component. The methods, operations, and logic block diagrams that are disclosed in some embodiments may be implemented or performed. The general-purpose processor may be a microprocessor, or the processor may be any conventional processor or the like. The operations of the methods disclosed with reference to some embodiments may be directly performed and completed by using a hardware decoding processor, or may be performed and completed by using a combination of hardware and software modules in the decoding processor. The software module may be located in a storage medium that is mature in the art, such as a random access memory, a flash memory, a read-only memory, a programmable read-only memory, an electrically erasable programmable memory, or a register. The storage medium is located in the memory. The processor reads information in the memory and completes the operations of the methods in combination with hardware thereof.

The memory in some embodiments may be a volatile memory or a nonvolatile memory, or may include a volatile memory and a nonvolatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM) serving as an external cache. Through illustrative but not limited description, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The memories of the system and method described herein are intended to include, but are not limited to, these types of memories.

Some embodiments further provide a computer-readable storage medium for storing a computer program.

In some embodiments, the computer-readable storage medium may be applied to the network device in some embodiments, and the computer program enables a computer to perform the corresponding processes implemented by the network device in the various methods in some embodiments.

In some embodiments, the computer-readable storage medium may be applied to the network elements in some embodiments, and the computer program enables the computer to perform the corresponding processes implemented by the network elements in the various methods in some embodiments.

Some embodiments further provide a computer program product, including computer program instructions.

In some embodiments, the computer program product may be applied to the network device in some embodiments, and the computer program instructions enable a computer to perform the corresponding processes implemented by the network device in the various methods in some embodiments.

In some embodiments, the computer program product may be applied to the network elements in some embodiments, and the computer program instructions enable a computer to perform the corresponding processes implemented by the network elements in the various methods in some embodiments.

Some embodiments further provide a computer program.

In some embodiments, the computer program may be applied to the network device in some embodiments. When the computer program runs on a computer, the computer is enabled to perform the corresponding processes implemented by the network device in the various methods in some embodiments.

In some embodiments, the computer program may be applied to the network elements in some embodiments. When the computer program runs on a computer, the computer is enabled to perform the corresponding processes implemented by the network elements in the various methods in some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data transmission method, performed by a communication device corresponding to a policy control function entity, comprising:
obtaining first support capability information indicating whether a first network device supports a first capability for quality of service processing of a data packet set at a first moment;
generating a first policy and charging control rule based on the first support capability information; and
transmitting the first policy and charging control rule.

2. The data transmission method according to claim 1, wherein the first policy and charging control rule comprises a first quality of service parameter for the data packet set based on the first support capability information indicating the first network device supports the first capability.

3. The data transmission method according to claim 1, wherein the first policy and charging control rule comprises a second quality of service parameter for a data packet based on the first support capability information indicating the first network device does not support the first capability.

4. The data transmission method according to claim 1, wherein the obtaining the first support capability information comprises obtaining the first support capability information from a target core network-network element comprising at least one of the policy control function entity, a unified data management network element, or a unified data repository network element, wherein the first support capability information is pre-configured in the target core network-network element.

5. The data transmission method according to claim 4, wherein the target core network-network element comprises the policy control function entity, the unified data management network element, and the unified data repository network element.

6. The data transmission method according to claim 1, wherein the obtaining the first support capability information comprises obtaining the first support capability information from a network management system.

7. The data transmission method according to claim 1, wherein the obtaining the first support capability information comprises obtaining the first support capability information from the first network device.

8. The data transmission method according to claim 1, further comprising:
receiving, based on a terminal being switched from the first network device to a second network device and a second data transmission support capability of the second network device being inconsistent with a first data transmission support capability of the first network device, a first notification message from the second network device indicating whether the second network device supports a second capability for quality of service processing of the data packet set at a current moment;
generating a second policy and charging control rule based on the first notification message; and
transmitting the second policy and charging control rule.

9. The data transmission method according to claim 1, further comprising:
obtaining a second notification message comprising third support capability information, the third support capability information being different from the first support capability information, and the third support capability information indicating whether the first network device supports a third capability for supporting quality of service processing of the data packet set at a second moment;
generating a third policy and charging control rule based on the third support capability information; and
transmitting the third policy and charging control rule.

10. The data transmission method according to claim 9, wherein the second notification message further comprises a value indicating a reason for the first network device not supporting the third capability based on:
the first support capability information indicating the first network device supports the first capability, and
the third support capability information indicating the first network device does not support the third capability.

11. A data transmission apparatus, comprising:
at least one memory configured to store computer program code; and
at least one processor configured to read the program code and operate as instructed by the program code, the program code comprising:
first obtaining code configured to cause at least one of the at least one processor to obtain first support capability information indicating whether a first network device supports a first capability for quality of service processing of a data packet set at a first moment;
first generating code configured to cause at least one of the at least one processor to generate a first policy and charging control rule based on the first support capability information; and
first transmitting code configured to cause at least one of the at least one processor to transmit the first policy and charging control rule.

12. The data transmission apparatus according to claim 11, wherein the first policy and charging control rule comprises a first quality of service parameter for the data packet set based on the first support capability information indicating the first network device supports the first capability.

13. The data transmission apparatus according to claim 11, wherein the first policy and charging control rule comprises a second quality of service parameter for a data packet based on the first support capability information indicating the first network device does not support the first capability.

14. The data transmission apparatus according to claim 11, wherein the first obtaining code is configured to cause at least one of the at least one processor to obtain the first support capability information from a target core network-network element comprising at least one of a policy control function entity, a unified data management network element, or a unified data repository network element, wherein the first support capability information is pre-configured in the target core network-network element.

15. The data transmission apparatus according to claim 11, wherein the first obtaining code is configured to cause at least one of the at least one processor to obtain the first support capability information from a network management system.

16. The data transmission apparatus according to claim 11, wherein the first obtaining code is configured to cause at least one of the at least one processor to obtain the first support capability information from the first network device.

17. The data transmission apparatus according to claim 11, wherein the program code further comprises:
receiving code configured to cause at least one of the at least one processor to receive, based on a terminal being switched from the first network device to a second network device and a second data transmission support capability of the second network device being inconsistent with a first data transmission support capability of the first network device, a first notification message from the second network device indicating whether the second network device supports a second capability for quality of service processing of the data packet set at a current moment;
second generating code configured to cause at least one of the at least one processor to generate a second policy and charging control rule based on the first notification message; and
second transmitting code configured to cause at least one of the at least one processor to transmit the second policy and charging control rule.

18. The data transmission apparatus according to claim 11, wherein the program code further comprises:
second obtaining code configured to cause at least one of the at least one processor to obtain a second notification message comprising third support capability information, the third support capability information being different from the first support capability information, and the third support capability information indicating whether the first network device supports a third capability for supporting quality of service processing of the data packet set at a second moment;
second generating code configured to cause at least one of the at least one processor to generate a third policy and charging control rule based on the third support capability information; and
second transmitting code configured to cause at least one of the at least one processor to transmit the third policy and charging control rule.

19. The data transmission apparatus according to claim 18, wherein the second notification message further comprises a value indicating a reason for the first network device not supporting the third capability based on:
the first support capability information indicating the first network device supports the first capability, and
the third support capability information indicating the first network device does not support the third capability.

20. A non-transitory computer-readable storage medium, storing computer code which, when executed by at least one processor, causes the at least one processor to at least:
obtain first support capability information indicating whether a first network device supports a first capability for quality of service processing of a data packet set at a first moment;
generate a first policy and charging control rule based on the first support capability information; and
transmit the first policy and charging control rule.
